(19) United States
(12) Patent Application Publication
(10) Pub. No.: US 2009/0112610 A1
(43) Pub. Date: Apr. 30, 2009

(54) Product authentication systems and methods

(75) Inventors: Bright Augustine Simons, Kumasi (GH); Ashifi Gogo, White River Junction, VT (US)

Correspondence Address: BRIGHT A. SIMONS, P.O. BOX 6040 ADUM-MAIN, KUMASI, GH

(73) Assignee: ADC Authentication Corporation

(21) Appl. No.: 11/980,954

(22) Filed: Oct. 31, 2007

(51) Int. Cl. G06Q 10/00; G06F 17/40

(52) U.S. Cl. 705/1

(57) ABSTRACT

Systems and methods for authorising distribution networks through mutual dependency of unit item authentication and batch authentication are provided through cascading authentication along the product packaging characteristics.

### BACKGROUND OF THE INVENTION

1. Field of the Invention

The present invention relates generally to product authentication and supply chain management. More particularly, the present invention relates to product- and stage-based authentication throughout a supply chain for ensuring quality, safety and origin of products.

2. Description of the Prior Art

Product authentication and supply chain management systems and methods are known in the art. However, there are problems with existing systems and methods as they generally require specialized reader or scanning devices for inputting markings on products, which therefore introduce infrastructure and/or costs to provide widespread compliance and effectiveness of the system to eliminate fraud, counterfeits, or quality issues associated with non-monitored or non-marked goods.

Examples of relevant US patents and/or publications include the following:

US Publication No. 20060165260 for Product Authenticity Validation System;

US Pub. No. 20060173896 for Authentication method and system for distributing items.

### SUMMARY OF THE INVENTION

A first aspect of the present invention is to provide a system for product authentication including at least one product and a corresponding series of suppliers for product components; and a cascading authentication associated with the product components further comprising a combination of many-time and/or one-time codes that are selectively activated for confirmation of supply source at predetermined points within the series, thereby providing for an automated, transparent supply chain and product authentication system.

A second aspect of the present invention is to provide a method for product authentication including the steps of providing a series of many-time and/or one-time codes; associating them with at least one product and a corresponding series of suppliers for product components; providing and activating codes that are transmittable via wireless communication devices to a database; authenticating the codes by comparison at predetermined points throughout the series with the corresponding information in the database, thereby providing for automated, transparent supply chain and product authentication.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram illustrating authentication code relationships of the systems and methods of the present invention.

FIG. 2 is a flow diagram illustrating process steps in accordance with an embodiment of the present invention.

FIG. 3 is a flow diagram illustrating steps relating to authentication code processing according to the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides improved security, quality, and reliability for supply chain networks and the products that are produced therefrom. In a method for product authentication according to the present invention, the method includes the steps of: providing a series of many-time and/or one-time codes; associating them with at least one product and a corresponding series of suppliers for product components; activating codes that are transmittable via wireless communication devices to a database; and authenticating the codes by comparison at predetermined points throughout the series with the corresponding information in the database, thereby providing for automated, transparent supply chain and product authentication. Also, according to the present invention, a system for product authentication is provided that includes at least one product and a corresponding series of suppliers for product components; a cascading authentication associated with the product components further comprising a combination of many-time and/or one-time codes that are selectively activated for confirmation of supply source at predetermined points within the series, thereby providing for an automated, transparent supply chain and product authentication system.

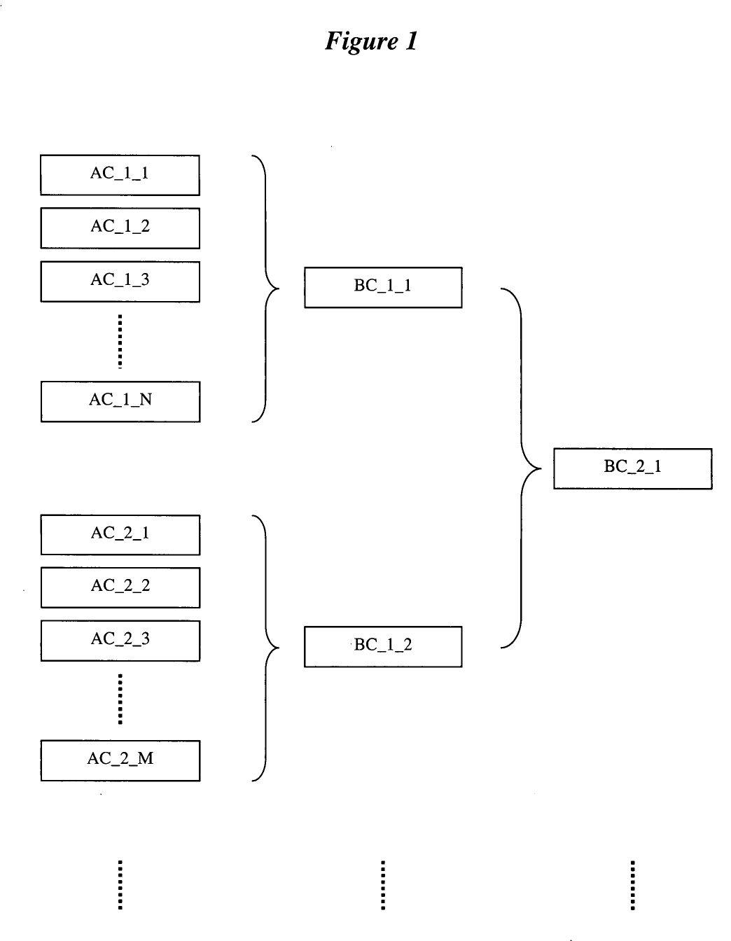

To enhance the organisation of supply chain networks, where an important consideration is enhanced visibility, unit-level unique coding is often not enough to ensure the tracking and tracing of assets. This is as a result of the standard practice of distribution management being to convey aggregate quantities of products to multiple destinations often in a sequential manner during which conveyance unit items remain invisible. In response to this constraint, distribution system managers assign codes to aggregate quantities of products (batch codes, BC). In the proposed invention such codes are unique, single-use from the point of view of the consignment recipient, and further linked to the unit items that together compose the aggregate quantity whereto said unique codes are associated. The unit item codes shall be referred to as authentication codes (AC). A schematic showing the hierarchy of such codes is presented in FIG. 1.

To guard against the diversion of product items, whether in bulk or in units, it is made a requirement of the distribution management system that an aggregate or batch of such product items be authenticated by means of an SMS, EMS, MMS, or other electronic transmission of the above-mentioned code to an authentication device or system. To enforce this requirement, the batch authentication action is made a prerequisite of any authentication action involving a product unit item (cascading authentication). A process of initialisation is instituted whereby unit authentication of products is allowed only when a successful batch authentication has been registered by the authentication device or system.

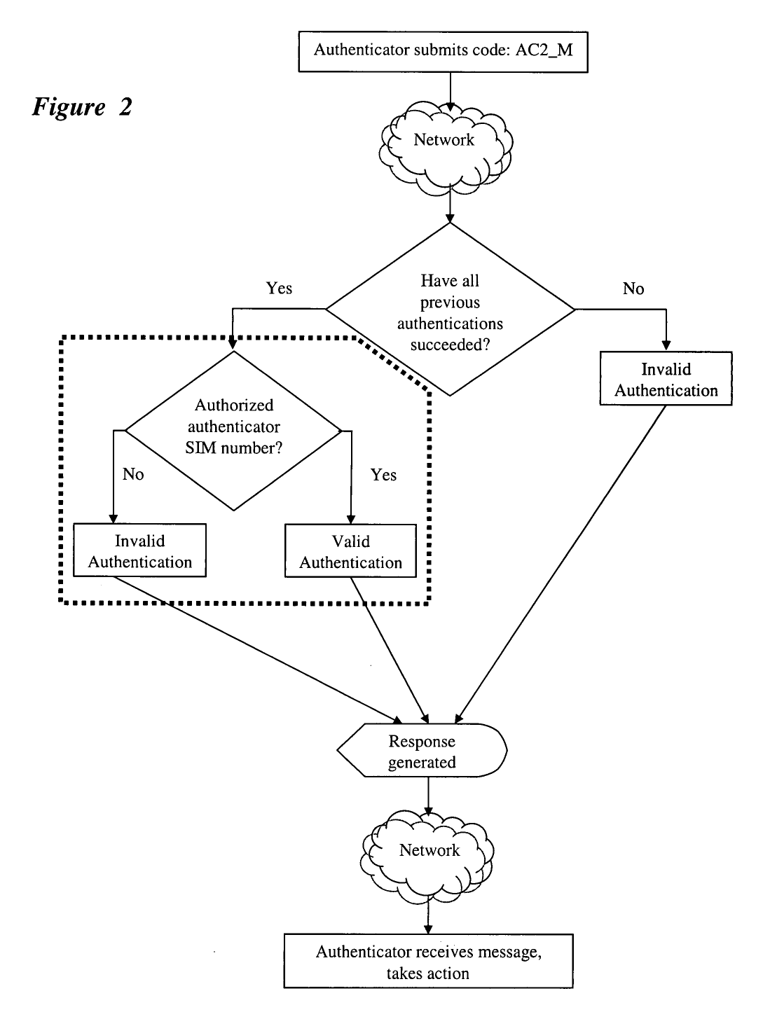

The standard practice of distribution management nevertheless still necessitates further measures to guard against the diversion of products off their allowed course within the distribution network. To achieve sufficient security of the supply line, it is sometimes not enough to rely solely on the security method of permitting initialisation of unit item authentication only after prior authentication of product aggregates. Further measures may be optionally instituted. By way of example and not limitation, the SIM card identification number of or associated with each authorised handler of a relevant batch may be used as an additional verification of legitimacy. The flowchart depicting this process is shown in FIG. 2.

Harmonised Line (Branch) Authentication

In a distribution network system where a desire exist to prevent the infiltration of unauthorised consignees or to strictly limit the handling of consignments to a number of authorised consignees, and where it is expected that issued stock should disburse at harmonised rates from consignees at identical levels of the supply chain, a further measure may be introduced whereby the initialization of unit-level or batch codes is not authorised at the subsequent level of the supply chain unless and until the specified number of consignees, and neither more nor less, have successfully authenticated their assigned batches by transmitting said batch codes to the authentication system.

In the cascading authentication paradigm batches are further optionally designated for specific geographic territories corresponding to specific distributor remits, the process of measuring distributor performance is therefore operable to be automated and assessed continuously. Importantly, according to the present invention, unit-level codes, because they belong to or are associated with a specific batch, provide a dynamic picture and overview of the rate of product uptake by end users for the benefit of the authentication system administrator and/or the manufacturer even where retailers have no incentive or means to communicate sales data to distributors. Said unit-level codes may thus present a detailed, high-level, picture of the distribution network, its evolution and spread, in a length of time far briefer than would be the case in the absence of a batch-level to unit-level linkage as generally described above.

Unitisation of Multi-Sourced Components

It is increasingly standard practice that for many consumer items, the constituent components of such items will be produced by different manufacturers and then assembled at an assembly line. A method is outlined in the proposed invention wherein unit-coded components are linked to the assembled product's unique code to prevent diversion of components post-assembly.

Product Recall and/or Product Liability Management

Occasionally, a manufactured article or product, despite having been subjected to a range of quality control measures by its manufacturer, will still be found to be defective only after said article has left the confines of the manufacturing plant and entered the distribution network. Various laws in many countries and moral compunction, as well as the concern for public esteem, will in these circumstances compel manufacturers to take measures to remove the defective article or articles from the distribution network as quickly as possible. Standard practice has been for manufacturers to coordinate such removals from the market with their authorised distributors and to issue forth periodic and sufficiently widespread advertisements about the situation in the mass media. Given the standard practice of labelling products with identical serial information, the usual approach has been to withdraw every item of a product type on the market if some defect is discovered in even a single item regardless of whatever differential conditions under which different batches of that product type were produced and hence regardless of whether the defect could be isolated within the pool of products in the distribution network.

According to the present invention, the use of unique batch coding allows the communication of targeted messages to different distributors instructing specified actions. Insofar as a significant number of end-users will be expected to verify the authenticity of products, communications or information are issued to such end-users to return the items to designated collection points prior to using said products. Similarly, coupons could be issued to the selfsame consumers via the same channel whereby they attempted to authenticate the product items affected by the recall to compensate for the material and emotional loss they would have suffered.

Warranty Registration

As an inducement to their customers manufacturers of products will often assume responsibility even beyond due liability to repair or replace defective or damaged articles that comes from their inventory. It is common practice for customers so indulged to return affected products by post or courier in expectation of a replacement with a new product or a refurbishment of the same article. Given the cumbersomeness of this process, particularly for large and busy manufacturers, manufacturers will often prefer a more sensitive recording system for keeping track of such customer actions for quicker resolution of systemic deficiencies in their production system. They will additionally prefer that a better system exists for verifying the genuineness of returned articles for which they are expected to issue a replacement. In these and associated scenarios, a method of registration is usually sought that attend to the concerns of manufacturers without imposing undue exertion on customers. According to the present invention, these and associated hurdles are managed by means of assigned single use alphanumeric codes with challenge response mechanisms that forewarns manufacturers of customers' intent to return a defective or damaged product and affirms the genuineness of customers' entitlement to that courtesy.

Referring now to the drawings in general, the illustrations are for the purpose of describing a preferred embodiment of the invention and are not intended to limit the invention thereto. FIG. 1 is a schematic showing the generation of authentication codes AC_M_N and batch codes BC_P_Q. The indices M, N, P, Q are identifiers (such as alphanumeric or machine readable characters) that represent the plurality of items to be managed in the supply chain per the invention.

FIG. 2 is a flowchart describing the process of cascading authentication. The dotted insert describes the optional additional security afforded by the SIM registration as described in detail in the invention.

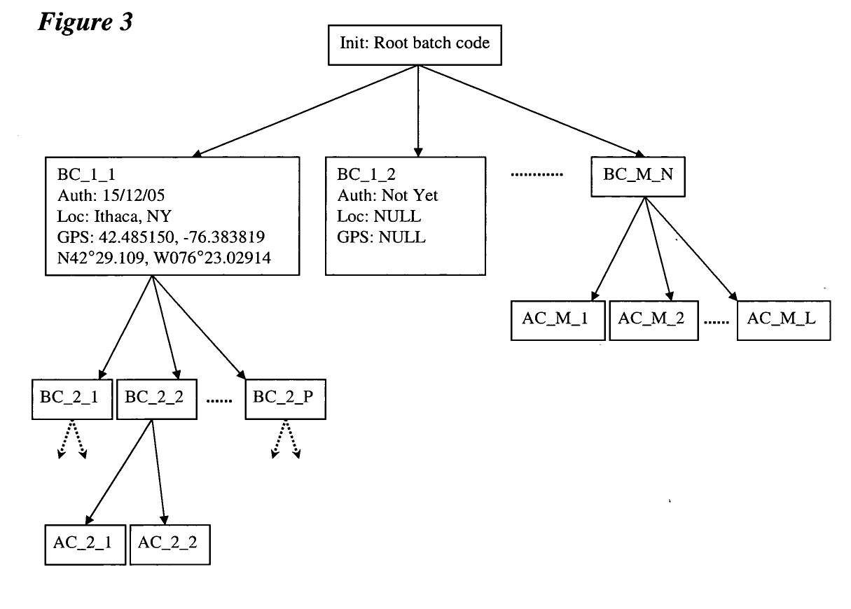

FIG. 3 is a flowchart detailing the hierarchical nature of codes as authentication requests are processed. It shows an initialized root batch code, and a mixture of validated and non-validated batch and authentication codes, with a sample of the peripheral authentication data that may be collected from the authentication device.

Product Lifecycle Management for Data on Start and End of Product Usage.

For certain items it often serves many important purposes for manufacturers to know with reasonable certainty a number of critical events in their use-cycles such as the beginning and end points of their use. By issuing special logging codes to consumers authenticating such products consumers can be induced by means of incentives to report such critical events to the manufacturer via the authentication system.

It is not uncommon for certain products to change ownership over time. Tracking the plurality of such ownership changes or transfers of ownership from the perspective of the manufacturer (or distributor/retailer) is a time-consuming task that currently depends on a concerted effort from the consumer. For high value goods like automobiles, consumers have a strong motivation for performing follow-up change of ownership with the manufacturer/service provider due to reasons such as preserving the validity of the vehicle's warranty. On the other hand, manufacturers of smaller items such as watches and portable electronics, tend to have a void of information regarding change of ownership and extended lifecycle data—information that could significantly impact the design of future products. An embodiment of this invention termed suffixing provides manufacturers automated notice of change of ownership or item resale events by affixing multiple codes specifically intended for such purposes, and providing incentives (if needed) for consumers to assert the genuineness of the used product. Prior to a sale, owners of a used product could electronically transmit the “product renewal code” to the manufacturer, obtaining a new code in the process and seamlessly notifying the manufacturer of a product lifecycle event. Such a code may come encoded in a graphic during issue to the recipient's device and forwarded on re-sale. The manufacturer could also impose strict re-use policies by regulating the response obtained upon product lifecycle authentication requests.

Use of Character Recognition to Automate Processes.

Where large consignments of product batches are concerned, manual transmission of codes by SMS usually prove inefficient and inimical to the streamlined processing of enterprise data. A method is outlined in the present invention whereby a standardised visual representation of alphanumeric characters is coupled with a character recognition system to speed up the process of code transmission for authentication and other distribution management systems.

In said system a coordinate system is established wherein alphabets and numerals are graphed vertically and horizontally. Dimensions are standardised such that magnification or contraction is strictly according to a fixed factor. A convention establishes the sequential direction of plotted points to determine a rule for sequential reading of plotted alphanumeric codes. An algorithm is thus created by means of which alphanumeric codes are extracted from visual symbols comprising of visible dots on a defined background. Such standardisation speeds up character reproduction and recognition and permits industrial-scale use of alphanumeric identification and product authentication systems.

Certain modifications and improvements will occur to those skilled in the art upon a reading of the foregoing description. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A system for product authentication comprising:
at least one product and a corresponding series of suppliers for product components;
a cascading authentication associated with the product components further comprising a combination of many-time and/or one-time codes that are selectively activated for confirmation of supply source at predetermined points within the series, thereby providing for an automated, transparent supply chain and product authentication system.

2. A method for product authentication comprising the steps of:
providing a series of many-time and/or one-time codes;
associating them with at least one product and a corresponding series of suppliers for product components;
activating codes that are transmittable via wireless communication devices to a database;
authenticating the codes by comparison at predetermined points throughout the series with the corresponding information in the database, thereby providing for automated, transparent supply chain and product authentication.
